(19) United States
(12) Patent Application Publication
(10) Pub. No.: US 2016/0147568 A1
(43) Pub. Date: May 26, 2016

(54) METHOD AND APPARATUS FOR DATA TRANSFER TO THE CYCLIC TASKS IN A DISTRIBUTED REAL-TIME SYSTEM AT THE CORRECT TIME

(71) Applicant: FTS COMPUTERTECHNIK GMBH, Wien (AT)

(72) Inventors: Stefan Poledna, Klosterneuburg (AT); Hermann Kopetz, Baden (AT); Martin Glück, Spannberg (AT)

(21) Appl. No.: 14/899,633

(22) PCT Filed: Jun. 5, 2014
(86) PCT No.: PCT/AT2014/050129

§ 371 Date: Dec. 18, 2015

(30) Foreign Application Priority Data
Jun. 24, 2013 (AT) A 50412/2013

(51) Int. Cl. G06F 9/48; G06F 1/14

(52) U.S. Cl. CPC G06F 9/4887; G06F 1/14

(57) ABSTRACT

The invention relates to a method for the time-correct data transfer between cyclic tasks in a distributed real-time system, which real-time system comprises a real-time communication system and a multiplicity of computer nodes, wherein a local real-time clock in each computer node is synchronised with the global time, wherein all periodic trigger signals zⁱ_{b} for the start of a new cycle i are derived in each computer node simultaneously from the advance of the global time, wherein these periodic trigger signals start the tasks, and wherein a task reads the output data of the other tasks from local input memory areas, to which the real-time communication system writes, and wherein a task writes the result data of the current cycle to a local output memory area, which is associated with the communications system, at an a priori determined individual production instant zⁱ_{f} before the end of a cycle, and wherein the schedules for the time-controlled communication system are configured such that the result data of a task present in the local output memory area is transported to the local input memory areas of the tasks requiring the data during the time interval <zⁱ_{f}, zⁱ⁺¹_{b}>, so that at the start of the following cycle this result data is available in the local input memory areas of the tasks that require this result data.

The invention relates to a method for the time-correct data transfer between cyclic tasks in a distributed real-time system, which real-time system comprises a real-time communication system and a multiplicity of computer nodes, wherein a local real-time clock in each computer node is synchronised with the global time.

The invention also relates to a distributed real-time system for carrying out such a method, which real-time system comprises a real-time communication system and a multiplicity of computer nodes, wherein the local real-time clock in each computer node is synchronised with the global time.

The present invention lies in the field of computer technology. It describes an innovative method for implementing, in a distributed real-time system, the a priori fixed time processing of a number of tasks working in parallel.

In many real-time applications an objective is divided into a multiplicity of tasks. A task is understood to mean a program-controlled encapsulated computing process which calculates the desired output data and a new version of inner state data from given input data and the inner state data stored in the task. Depending on the capability of the available computer node, a single task or a number of tasks (multi-tasking) can be performed simultaneously on one computer node. In a multi-tasking system the purpose of the (middleware) and of the subordinate operating system of a computer node is to provide the required resources for the processing of a task, to manage the communication channels, and to protect the task against unauthorised access by other tasks.

The logic, determined at system level, of the given assignment defines the exact sequence of the performance of the tasks. In a real-time system not only the logical sequence of the task execution, but also the precise time-based planning of the task are of great importance so that the response time of the system can be minimised.

If, for example in a system for the autonomous control of a vehicle, different sensor systems (for example optical cameras, laser, radar) monitor the moving surroundings of the vehicle, for example a pedestrian, it must be ensured that the different tasks for detecting the sensor data monitor the surroundings at the same instant in time so as to be able to form an image of the surroundings that is consistent at this instant in time. This simultaneity is given when tasks that can access a sensor system read the sensor data immediately after the start of a new cycle, since all tasks start a new cycle at the same time.

The object of the invention is to specify a way in which, in a distributed cyclic time-controlled real-time system, the tasks and the communication can be synchronised in order to ensure an optimal response time of the system.

This object is achieved with a method as described in the introduction in that, in accordance with the invention, all periodic trigger signals zⁱ_{b} for the start of a new cycle i are derived in each computer node simultaneously from the advance of the global time, wherein these periodic trigger signals start the tasks, and wherein a task reads the output data of the other tasks from local input memory areas, to which the real-time communication system writes, and wherein a task writes the result data of the current cycle to a local output memory area, which is associated with the communications system, at an a priori determined individual production instant zⁱ_{f} before the end of a cycle, and wherein the schedules for the time-controlled communication system are configured such that the result data of a task present in the local output memory area is transported to the local input memory areas of the tasks requiring the data during the time interval <zⁱ_{f}, z¹⁺¹_{b}>, so that at the start of the following cycle this result data is available in the local input memory areas of the tasks that require this result data.

In a time-controlled real-time system the synchronisation of the tasks that are to be performed in different computer nodes is achieved via a global timebase. For this purpose the time is divided into a number of cycles synchronised across the system.

In accordance with the invention, at the start of a cycle, which is determined by the advance of the global time, for example at the instant zⁱ_{b} of the cycle zⁱ, the sensor data is taken from all distributed sensors. A task associated with a sensor undertakes a preliminary processing of the sensor data and normally makes the results of this preliminary processing available to a time-controlled communication system in an output memory area of the task before the end of the current cycle, for example at the production instant zⁱ_{f} of the cycle i. In the time interval <zⁱ_{f}, zⁱ⁺¹_{b}> before the start of the following cycle, the time-controlled communication system transports the results to the input memory areas of the tasks that require these results for the further processing. At the start of the following cycle, at the instant zⁱ⁺¹_{b} all necessary input data is therefore available in the specified input areas of the following tasks for further processing.

No method anticipating the innovation disclosed here could be found in the searched patent literature [1, 2].

Advantageous embodiments of the method according to the invention and of the real-time system according to the invention, which embodiments can be implemented individually or in any combination, are detailed hereinafter:
a task sets an ageing index to zero after the start and, in addition to the result data, writes the current value of the ageing index to the output memory area, which is associated with the communication system; since the processing duration of a task is data-dependent, the result of a task is provided with an ageing index, which specifies whether a delay in the task processing has occurred. The separation of the time-based scheduling of the tasks and the time-controlled communication from the processing logic within a task allows a flexible allocation of the tasks to the available distributed hardware architecture;
a task that cannot provide the result data of the current cycle at the a priori determined production instant zⁱ_{f} before the end of a cycle i increases the ageing index by one and places the result data in the output area at the production instant zⁱ⁺¹_{f} of the following cycle;
all tasks that can access a sensor system read the sensor data simultaneously at the start of a new cycle;
the production instants of the tasks are staggered;
the latest production instant and therefore the longest processing interval are assigned to the task having the greatest processing effort;
all time-controlled events are sparse events;
the internal global time is synchronised with an external timebase;
the time-based execution sequence of the cooperating tasks defined at system level and the task software are not changed when the hardware allocation of one or more tasks is changed;
a number of copies of a task are performed simultaneously on different computer nodes.

The present invention will be explained on the basis of the following drawing, in which

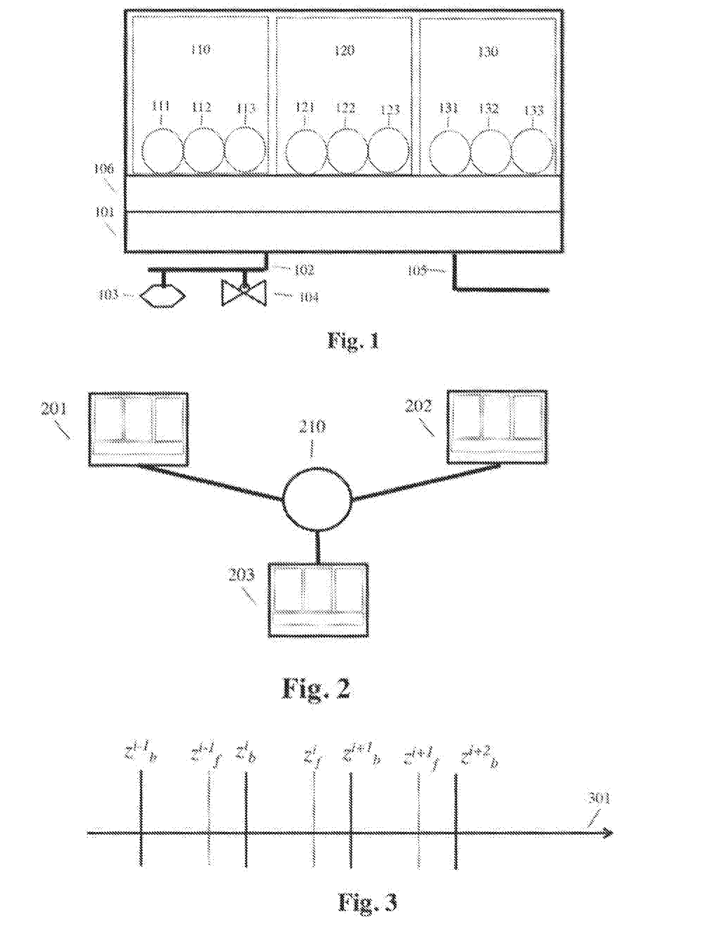

FIG. 1 shows the structure of a multi-tasking computer node,

FIG. 2 shows a distributed real-time system having three computer nodes, and

FIG. 3 shows the course over time of the processing of tasks.

The following specific example shows one of the many possible embodiments of the new method.

FIG. 1 illustrates a physical computer node, which has been allocated three tasks, the tasks 110, 120 and 130. These three tasks are managed by a middleware and an operating system 106. The hardware of the computer node 101 is connected via a sensor bus 102 to an input sensor 103 and an actuator 104, and via a communication signal 105 to a time-controlled message distributor unit 203 (see FIG. 2).

Each task has three memory areas. The task 110 has the input memory area 111, the inner state memory 112, and an output memory area 113. The input memory 111 of the task 110 is also the output memory of the real-time communication system. Since time-controlled state data is transmitted, there is no need for any queue management in the real-time communication system. Each new version of a state message overwrites the old version [6, p. 91] in the input memory area 111. The inner state memory 112 contains the data transferred from the previous cycle to the following cycle of the task 110. The state memory 112 is read immediately after the start of a cycle, and the new values are written to said state memory immediately before the start of the following cycle. The output memory area 113, to which data is written before the end of the cycle i at the production instant zⁱ_{f}, contains the results of the task 110 in the cycle i. In the interval <zⁱ_{f}, zⁱ⁺¹_{b}> the real-time communication system transfers the results from the output memory area 113 with a result message into the input memory of the tasks that require this data in the following cycle.

The tasks 120 and 130, similarly to the task 110, likewise each have three memory areas.

A distributed real-time system consisting of the three computer nodes 201, 202 and 203 and a message distributor unit 210 is illustrated in FIG. 2. The message distributor unit, the controller, in particular communication controller in the computer nodes, and the connections between the message distributor unit and the computer nodes or controllers thereof form the real-time communication system. The three computer nodes 201, 202 and 203, which are constructors in accordance with FIG. 1, communicate by means of state messages, which are conveyed by the time-controlled message distributor unit 210 at a priori determined instants in time. TTEthernet [4] is an example of a time-controlled communication system of this type.

FIG. 3 shows the course over time of successive cycles. The advance of the global time is illustrated on the abscissa 301. At the instants in time zⁱ⁻¹_{b}, zⁱ_{b}, zⁱ⁺¹_{b} and zⁱ⁺²_{b} the trigger signals for a new cycle are derived from the global time simultaneously in all computer nodes of the distributed real-time system, and the tasks are started with these trigger signals.

The simultaneity of the actions is achieved via the internal global time. The precision of the global clock synchronisation determines the granularity of the internal global time and therefore the minimal interval between sparse events [3, p. 64]. All-time-controlled actions, such as the start of the cycle or the sending of a message are advantageously sparse events. Only when, in a distributed system, all-time-controlled actions are sparse events is the simultaneity of events in the overall system clearly determined.

The global time can be synchronised with an external timebase, for example the GPS (general positioning system) time. GPS enables a time accuracy of better than 100 nsec. If a number of autonomous systems synchronise their internal global time with the GPS time, the simultaneity of the data capture can be implemented beyond the system limits of an autonomous system.

In accordance with the invention the schedules of the time-controlled communication must be synchronised with the production instants zⁱ_{f} of the task processing, such that the message transport can start directly after a production instant zⁱ_{f}.

Whereas all cycles of all tasks start at the same time, the production instants of the tasks are not determined simultaneously, but individually for each task. The staggered production instants of the tasks enable the communication system to transport the messages without conflict in succession from the transmitters to the receivers. The longest processing interval <zⁱ_{b} zⁱ_{f}> is preferably assigned to the task having the greatest processing effort.

The following example shows the typical magnitude of the parameters in an application:
number of computer nodes: 10
average number of tasks per computer node: 5
number of tasks: 50
bandwidth of the TTEthernet communication system: 1 Gbit/sec
accuracy of the clock synchronisation: 100 nsec
duration of a cycle: 10 msec
average number of bytes in a result message: 1000
duration of the transport of a result message: 10 μsec
minimum processing duration of a task: 9500 μsec
maximum processing duration of a task: 9990 μsec

When the processing duration of a task, for example of the task 110, is dependent on the complexity of the input data, it may be that the processing of the task 110 in the cycle i is still not complete at the scheduled production instant zⁱ_{f}. In this case the (old) output data of the cycle i−1 is retained in the output area 113, preferably in accordance with the state semantic. The task 110 continues its processing in the following cycle i+1 and writes the results to the output area 113 at the production instant zⁱ⁺¹_{f}.

In the output region 113 a data field for an ageing index is preferably provided. This ageing index is set to zero once the input data has been read from the memory area 111. When the task 110 cannot complete the result data of the current cycle at the a priori determined production instant z¹_{f} before the end of said cycle, the delayed task then increases the ageing index by one. The result data of the cycle i is placed in the output area 113 at the production instant zⁱ⁺¹_{f} of the following cycle. Since the ageing index is transferred with the result data are in the result message, the chronologically subsequent task can determine that a delay has occurred in the previous task 110 and can take into consideration this delay during the further processing.

The chronological execution sequence of the tasks determined at system level can be implemented in a distributed real-time system, in which the computer nodes support multi-tasking and communicate via a time-controlled communication system, by means of different hardware allocations. The hardware allocation is understood to mean the allocation of tasks to the computer nodes, i.e. to the hardware. Depending on the observed resource requirement, a task of a computer node that is overloaded and where the tasks often exceed the scheduled production instants zⁱ_{f} can be allocated to another, more powerful computer node. For this purpose, the schedules of the task activation and of the time-controlled communication have to be re-configured—the tasks themselves do not have to be changed. The strict separation of the task software from the hardware allocation and the time-based scheduling of the task activation and the time-controlled communication increases flexibility and enables quick adaptation of the system configuration to new requirements.

In the proposed architecture it is also possible to carry out a number of copies of a task in order to increase the reliability. When a fail-silent fault model can be assumed, the failure of one copy can thus be masked by the copy of a task working in parallel.

### CITED LITERATURE

[1] U.S. Pat. No. 8,453,151. Manczak. Method and system for coordinating hypervisor scheduling. Granted May 28, 2013.
[2] US Pat. Application 20080273527. Short. Distributed System. Published Nov. 6, 2008.
[3] Kopetz, H. Real-Time Systems, Design Principles for Distributed Embedded Applications. Springer Publishing. 2011.
[4] SAE Standard von TTEthernet. URL: http://standards.sae.org/as6802

1. A method for the time-correct data transfer between cyclic tasks in a distributed real-time system, which real-time system comprises a real-time communication system and a multiplicity of computer nodes, wherein a local real-time clock in each computer node is synchronised with the global time, characterised in that all periodic trigger signals zⁱ_{b} for the start of a new cycle i are derived in each computer node simultaneously from the advance of the global time, wherein these periodic trigger signals start the tasks, and wherein a task reads the output data of the other tasks from local input memory areas, to which the real-time communication system writes, and wherein a task writes the result data of the current cycle to a local output memory area, which is associated with the communications system, at an a priori determined individual production instant zⁱ_{f} before the end of a cycle, and wherein the schedules for the time-controlled communication system are configured such that the result data of a task present in the local output memory area is transported to the local input memory areas of the tasks requiring the data during the time interval <zⁱ_{f}, zⁱ⁺¹_{b}>, so that at the start of the following cycle this result data is available in the local input memory areas of the tasks that require this result data.

2. The method according to claim 1, characterised in that a task sets an ageing index to zero after the start and, in addition to the result data, writes the current value of the ageing index to the output memory area, which is associated with the communication system.

3. The method according to claim 1 or 2, characterised in that a task that cannot provide the result data of the current cycle at the a priori determined production instant zⁱ_{f} before the end of a cycle i increases the ageing index by one and places the result data in the output area at the production instant zⁱ⁺¹_{f} of the following cycle.

4. The method according to one of claims 1 to 3, characterised in that all tasks that can access a sensor system read the sensor data simultaneously at the start of a new cycle.

5. The method according to one of claims 1 to 4, characterised in that the production instants of the tasks are staggered.
